(19) United States
(12) Patent Application Publication
(10) Pub. No.: US 2013/0137335 A1
(43) Pub. Date: May 30, 2013

(54) CURING DEVICE FOR LCD PANELS

(71) Applicants: Fengming Yin, Shenzhen (CN); Wen pin Chiang, Shenzhen (CN)

(72) Inventors: Fengming Yin, Shenzhen (CN); Wen pin Chiang, Shenzhen (CN)

(21) Appl. No.: 13/376,186

(22) PCT Filed: Dec. 3, 2011
(86) PCT No.: PCT/CN2011/083421

§ 371 Date: Dec. 4, 2011

(30) Foreign Application Priority Data
Nov. 29, 2011 (CN) 201110386611.0

(51) Int. Cl. H01J 9/00

(52) U.S. Cl. 445/60

(57) ABSTRACT

A curing device for liquid crystal display (LCD) panels comprises at least one layer of curing unit. The curing unit comprises two oppositely arranged platforms used for bearing LCD panels, lamps arranged between the two platforms, and an LCD panel bearing structure on the lower surface of the upper platform. Because of the LCD panel bearing structure, lamps between the two platforms can irradiate LCD panels above and below the lamps at the same time, more LCD panels can be cured in the irradiation furnace in the same size, or similarly, only a smaller irradiation furnace is needed to cure an equivalent number of LCD panels. The design of the curing device is optimized. In addition, irradiation surfaces above the lamps are fully used; compared with the existing curing device, the curing device of the present invention can greatly reduce energy consumption when used to cure an equivalent number of LCD panels.

### TECHNICAL FIELD

The present invention relates to the field of liquid crystal display, in particular to a curing device for LCD panels.

### BACKGROUND

LCD panel is an important component of a liquid crystal display device. The production technology, including irradiating the sealed LCD panel with injected liquid crystal by using UV lamps, is very complex.

Generally, an FUVO machine is used for irradiating LCD panels. Take an FUVO machine with 30 irradiating furnaces as an example, an irradiating furnace of the FUVO machine is shown is FIG. 1, the interior of the irradiating furnace is divided into 16 layers, so 30*16=480 pieces of glass can be cured at the same time, and 480*16=19200 lamps are used. One platform is used for each piece of glass (i.e. each layer), so 480 platforms are used. Each layer of the furnace is 190 mm in height, so the height of each furnace is 190*(16−1)=2,850 mm. When the above-mentioned FUVO machine is used, we can assume that 110W UV lamps are used, if the price of each UV lamp is 1,000 RMB, the lifetime of the lamp is 8000 hours, then 19,200*(365 days*24 hours/8,000 hours)=21,024 lamps will be used, the total cost is very high and is approximately 21,020,000 RMB; 19,200*110W*365 days*24 hours=18,500,000 KW. H of electric power will be consumed each year; the height of the furnace cavity is 2850 mm, and large space will be occupied.

### SUMMARY

The aim of the present invention is to provide a high-efficient and energy-saving curing device for LCD panels.

The purpose of the present invention is achieved by the following technical schemes. A curing device for liquid crystal display (LCD) panels comprises at least one layer of curing unit. The curing unit comprises two oppositely arranged platforms used for bearing LCD panels, lamps arranged between the two platforms, and an LCD panel bearing structure on the lower surface of the upper platform.

Preferably, the curing device comprises multiple layers of curing units; for two adjacent curing units, the lower platform of the upper curing unit is used as the upper platform of the lower curing unit, so the two adjacent curing units share the platform between them. In such design, the platform can be shared, so the spatial utilization can be improved.

Preferably, the curing device comprises multiple layers of curing units, and each curing unit is provided with an upper platform and a lower platform. These curing units are independent of each other. Even if one curing unit is completely damaged, the other one can be normally used.

Preferably, the bearing structure is composed of multiple vacuum slots on the lower surface of said platform which are used for adsorbing an LCD panel. The vacuum slots can adsorb the back surface of the LCD panel (i.e. the surface that will not be directly irradiated), the surface to be irradiated of the LCD panel will not be influenced, so the LCD panel can be well irradiated and cured

Preferably, the bearing structure is composed of bracing frames on the lower surface of the platform which are used for bracing an LCD panel. The structure of the bearing structure is simple, and the production price is low.

Preferably, a cooling system is arranged in the platform to ensure that the temperature of the glass will not rise after the glass absorbs the energy of the lamps, so the performance of the liquid crystal will not be damaged.

Preferably, the cooling system is a water cooling system. The water cooling has the advantages of convenience and good effect.

Preferably, the lower platform of the curing unit is provided with take-and-place slots, so the LCD panel can be taken away and placed conveniently, and the safety of the LCD panel can be ensured.

Preferably, in each curing unit, the distance between the lamps and the upper platform is greater than that between those lamps and the lower platform. Therefore, there is adequate space to take away and place the upper LCD panel; because the upper LCD panel does not come into contact with the platform directly, which will reduce the cooling effect, the increased distance can ensure that the temperature of the LCD panel will not rise.

Preferably, in each curing unit, the distance between the upper platform and the lower platform is 200 to 300 mm. This distance can be adjusted in accordance with the irradiation intensity of lamps and the need for taking away and placing LCD panels so as to realize the optimum design.

Preferably, in each curing unit, the distance between the lamps and the upper platform is 50 to 150 mm. This distance can be adjusted in accordance with the irradiation intensity of lamps and the need for taking away and placing LCD panels so as to realize the optimum design.

Preferably, the lamps are UV lamps. Ultraviolet curing has the advantages of rapid curing rate and good curing effect, and is a good curing condition.

Because of the LCD panel bearing structure on the lower surface of the upper platform, the lower one of two adjacent platforms can be used to bear an LCD panel, and the upper one can be used to fix another LCD panel; lamps between the two platforms can irradiate the upper and the lower LCD panels at the same time, more LCD panels can be cured in the irradiation furnace in the same size, or similarly, only a smaller irradiation furnace is needed to cure an equivalent number of LCD panels. The design of the curing device is optimized, and the size is reduced. In addition, irradiation surfaces above the lamps are fully used, and the utilization rate of energy of the lamps is improved; compared with the existing curing device, the curing device of the present invention can greatly reduce energy consumption when used to cure an equivalent number of LCD panels.

### DESCRIPTION OF FIGURES

FIG. 1 shows the structure of the irradiating furnace of the existing curing device.

FIG. 2 shows the structure of the irradiating furnace of the first embodiment of the present invention.

FIG. 3 shows the structure of the irradiating furnace of the second embodiment of the present invention.

wherein: 10, UV lamp; 20, LCD panel; 30, platform; 31, take-and-place slot; 32, vacuum slot; 100, curing unit.

### DETAILED DESCRIPTION

The present invention is further described by figures and the preferred embodiments as follows.

The curing device for liquid crystal display (LCD) panels of the present invention comprises multiple irradiating furnaces, wherein each irradiating furnace has at least one layer of curing unit. The curing unit comprises two oppositely arranged platforms used for bearing LCD panels, lamps arranged between the two platforms, and an LCD panel bearing structure on the lower surface of the upper platform. Because of the LCD panel bearing structure on the lower surface of the upper platform, the lower one of two adjacent platforms can be used to bear an LCD panel, and the upper one can be used to fix another LCD panel; lamps between the two platforms can irradiate the upper and the lower LCD panels at the same time, more LCD panels can be cured in the irradiation furnace in the same size, or similarly, only a smaller irradiation furnace is needed to cure an equivalent number of LCD panels. The design of the curing device is optimized, and the size is reduced. In addition, irradiation surfaces above the lamps are fully used, and the utilization rate of energy of the lamps is improved; compared with the existing curing device, the curing device of the present invention can greatly reduce energy consumption when used to cure an equivalent number of LCD panels.

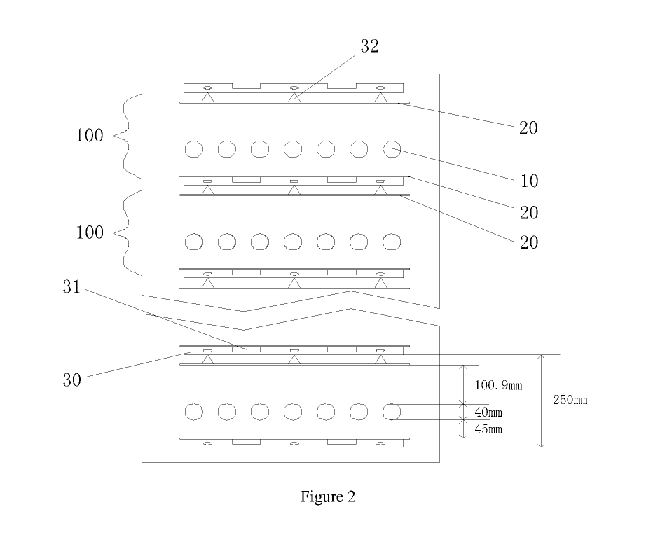

FIG. 2 shows one specific embodiment of the present invention, which is an irradiating furnace of the curing device. The irradiating furnace has eight layers of curing units, two adjacent curing units 100 share one platform 30, namely that the lower platform 30 of the upper curing unit 100 is the upper platform 30 of the lower curing unit 100. In each curing unit 100, a group of lamps are arranged between platforms 30, so there are eight groups of lamps and nine platforms in the irradiating furnace, wherein lamps 10 are UV lamps, 40 UV lamps are arranged in each layer, a water cooling system is arranged in each platform 30 to ensure that the temperature of the LCD panel will not rise after the LCD panel absorbs the energy of the lamps, so the performance of the liquid crystal will not be damaged; in each curing unit, the lower surface of the upper platform is provided with forty-five vacuum slots 32 to adsorb LCD panel 20, the quantity of vacuum slots 32 can be adjusted in accordance with the dimension and weight of LCD panel 20, and the upper surface of lower platform 30 can also be used for bearing LCD panel 20. The upper surface of the platform 30 is provided with take-and place slots 31, so LCD panel 20 placed on the platform 30 can be taken away and placed conveniently. The distance between lamps 10 and LCD panel 20 above the platform 30 is 100.9 mm, and the distance can be adjusted between 50 and 150 mm, however space sufficient to take away the LCD panel 20 shall be left; the distance between lamps 10 and LCD panel 20 below the lamps 10 is 45 mm, a distance greater than or smaller than 45 mm is also acceptable, but the distance of 45 mm can ensure a good curing effect.

In this embodiment, as shown in FIG. 2, the distance between lamps 10 and the LCD panel 20 below the lamps 10 is 45 mm; the distance between two platforms 30 is 250 mm, and that distance can be adjusted between 200 and 300 mm in accordance with the quantity and irradiation intensity of the lamps; vacuum slots 32 above lamps 10 and below upper platform 30 are used for adsorbing another LCD panel, so 40 lamps in the same group can irradiate 2 LCD panels at the same time. Take 1G8.5 generation LCD panel glass for example, the weight of the glass is about 20 kg, the vacuum pressure required for vacuum adsorption is about −80 kp, the radius of each vacuum slot is about 5 mm; according to p=f/s, about 31 vacuum slots are needed, 45 vacuum slot are designed in the non-display area of the glass to ensure complete and stable adsorption, so 45*240 (one half of the glass needs to adsorb)=10800 vacuum slots are needed (the total cost is about 500,000 RMB), the distance between the lamps and the LCD panel above the lamps is 100.9 mm, each irradiating furnace has eight layers of curing units, and eight groups of lamps are used, so the total number of the lamps is 9,600; there are nine platforms, so the height of the irradiating furnace is about 250*9=2250 mm.

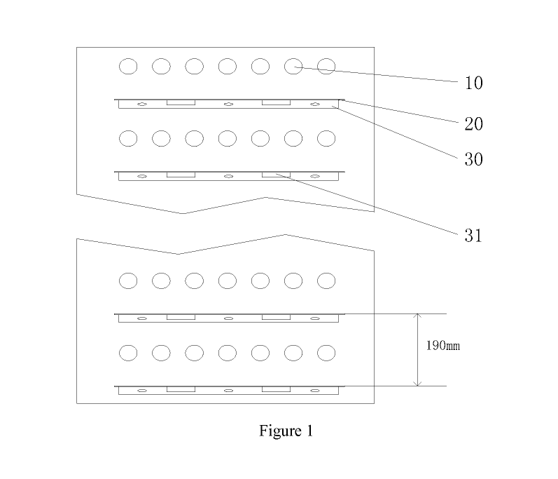

Compared with the existing irradiating furnace in FIG. 1, only 19200−9600=9600 lamps are used in the embodiment of the present invention, the energy consumption is reduced to 9,600*110W*365 days*24 hours=9,250,000 KW. H, 16−9=7 platforms are used, and the height of the irradiating furnace is 2,850−2,250=600 mm.

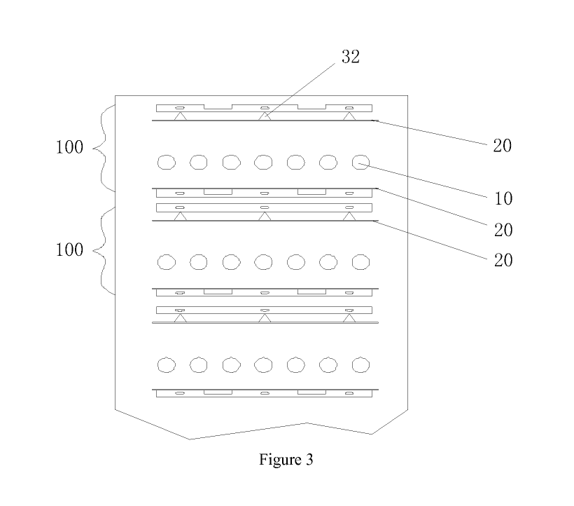

FIG. 3 shows the second embodiment of the present invention, unlike Embodiment 1, curing units 100 are independent of each other, platform 30 is not shared, namely that 8 layers of curing units require 16 layers of platforms. In this embodiment, if one curing unit 100 is damaged, other curing units can be normally used. However, both the overall height of the irradiating furnace and quantity of required parts are increased.

In the embodiment of the present invention, besides vacuum slots, other structures, such as bracing frames, can be used as the bearing structure on the lower surface of the upper platform; however, the vacuum slots will not obscure the irradiated surface of the LCD panel, and is the optimal selection.

The above content is detailed description of the present invention by using specific preferred embodiments. However, this present invention is not limited to these specific embodiments. For the ordinary technical personnel in the technical field of the present invention, on the premise of keeping the conception of the present invention, the technical personnel can also make simple deductions or replacements, and all of which should be considered to belong to the protection scope of the present invention.

We claim:

1. A curing device for liquid crystal display (LCD) panels, comprising at least one layer of curing unit, the curing unit comprises two oppositely arranged platforms used for bearing LCD panels, lamps arranged between the two platforms, and an LCD panel bearing structure on the lower surface of the upper platform.

2. The curing device for LCD panels of claim 1, wherein said curing device comprises multiple layers of curing units; for two adjacent curing units, the lower platform of the upper curing unit is used as the upper platform of the lower bearing unit, so the two adjacent curing units share the platform between them.

3. The curing device for LCD panels of claim 1, wherein said curing device comprises multiple layers of curing units, and each curing unit is provided with an upper platform and a lower platform.

4. The curing device for LCD panels of claim 2, wherein said bearing structure is composed of multiple vacuum slots on the lower surface of said platform which are used for adsorbing an LCD panel.

5. The curing device for LCD panels of claim 2, wherein said bearing structure is composed of bracing frames on the lower surface of said platform which are used for bracing an LCD panel.

6. The curing device for LCD panels of claim 1, wherein a cooling system is arranged in the said platform.

7. The curing device for LCD panels of claim 6, wherein said cooling system is a water cooling system.

8. The curing device for LCD panels of claim 7, wherein the lower platform of said curing unit is provided with take-and-place slots which will be used when the LCD panel is taken away and placed.

9. The curing device for LCD panels of claim 1, wherein in each curing unit, the distance between the lamps and the upper platform is greater than that between those lamps and the lower platform.

10. The curing device for LCD panels of claim 1, wherein in each curing unit, the distance between the upper platform and the lower platform is 200 to 300 mm.

11. The curing device for LCD panels of claim 1, wherein in each curing unit, the distance between the lamps and the upper platform is 50 to 150 mm.

12. The curing device for LCD panels of claim 1, wherein said lamps are UV lamps.

13. The curing device for LCD panels of claim 3, wherein said bearing structure is composed of multiple vacuum slots on the lower surface of said platform which are used for adsorbing an LCD panel.

14. The curing device for LCD panels of claim 3, wherein said bearing structure is composed of bracing frames on the lower surface of said platform which are used for bracing an LCD panel.
